(19) United States
(12) Patent Application Publication
(10) Pub. No.: US 2024/0330848 A1
(43) Pub. Date: Oct. 3, 2024

(54) COMPUTERIZED SYSTEMS AND METHODS FOR INTELLIGENT ALLOCATION OF PRODUCTS IN A WAREHOUSE

(71) Applicant: Coupang Corp., Seoul (KR)

(72) Inventors: Issac Kwon, Gyeonggi-do (KR); Hyunah Joo, Seoul (KR); Dayoung Kim, Gyeonggi-do (KR); Wooyoung Jeong, Gyeonggi-do (KR); Sunhee Hwang, Gyeonggi-do (KR); Sangho Lee, Seoul (KR)

(21) Appl. No.: 18/128,412

(22) Filed: Mar. 30, 2023

(51) Int. Cl. G06Q 10/087; B65G 1/137; G05D 1/02

(52) U.S. Cl. CPC G06Q 10/087; B65G 1/1371; B65G 1/1373; B65G 2203/0216

(57) ABSTRACT

Systems and methods for intelligent allocation of products in a warehouse. Methods include when the SKU does not correspond to an AGV zone of the warehouse, commanding a mobile receptacle to transport the SKU to a manual zone of the warehouse; when the SKU does correspond to an AGV zone of the warehouse: when the SKU identifier comprises a pallet tag: transporting the SKU to an AGV zone of the warehouse; when the SKU identifier does not comprise a pallet tag: calculating a first allocation of a product to be directed to a manual zone and a second allocation of the a product to be directed to an AGV zone, transporting the first allocation to a manual zone, and transporting the second allocation to an AGV zone.

### TECHNICAL FIELD

The present disclosure generally relates to computerized systems and methods for intelligent allocation of products in a warehouse. In particular, embodiments of the present disclosure relate to inventive and unconventional systems for flexibly transporting products to different zones in a warehouse at the inbound point of the process, regardless of whether the product is already registered for a particular zone of the warehouse.

### BACKGROUND

A warehouse (e.g., a fulfillment center) may have a plurality of zones dedicated to different functions. For example, a warehouse may have one zone that is for manual handling of stock keeping units (SKUs) (e.g., inbound receiving SKUs, unloading SKUs, etc.) and another zone that is for automated guided vehicle (AGV) handling of SKUs (e.g., stowing SKUs, picking SKUs, placing SKUs, restowing SKUs, evaluating SKUs, etc.). The different zones may be allocated within a warehouse differently depending on the warehouse (e.g., one warehouse may be ⅔ manual zone and ⅓ AGV zone; another warehouse may be ½ manual zone and ½ AGV zone, etc.).

SKUs and products in SKUs typically are not designated as “manual SKUs” to be directed to a manual zone or “AGV SKUs” to be directed to an AGV zone when they are received by a warehouse (i.e., inbound). As a warehouse receives products or SKUs, each product or SKU is scanned and designated as a manual SKU or an AGV SKU. Products or SKUs are placed in a mobile receptacle (e.g., tote) based on whether they should be in the manual zone or the AGV zone.

Typical warehouses, however, suffer from constraints. For example, SKUs that are registered as AGV SKUs can only be stowed in the AGV zone. This restriction makes it difficult to fully leverage the AGV zone's utilization. For example, the manual zone may need to transfer SKUs to the AGV zone due to the manual zone reaching full capacity faster than the AGV zone. A warehouse may suffer low throughput, low efficiency, and low profits due to the manual SKUs being restricted to the manual zone and, consequently, the manual zone being unable to receive additional SKUs when it reaches full capacity.

In order to transfer SKUs from the manual zone to the AGV zone, a warehouse must manually register the SKUs to be stowed in the AGV zone. A typical process to transfer SKUs from the manual zone to the AGV zone may proceed as follows: a system must select a consolidation SKU that is in the manual zone, change the status of that consolidation SKU to unsellable, determine the location of the SKU in the manual zone, pick up the SKU from the manual zone, transfer the SKU in the manual zone to a mobile receptacle, stow the SKU in a buffer zone of the warehouse via the mobile receptacle, register the SKU as an AGV SKU, pick up the AGV SKU from the buffer zone, send a request to an external system, and stow the AGV SKU in the AGV zone when the external system accepts the request.

While these typical systems increase the inventory level in the AGV zone, thereby increasing the overall area utilization of a warehouse, these typical systems waste significant amounts of time and resources to perform this transfer process due to the restrictions of typical warehouses. As a result, typical warehouses have unstable inventory in the AGV zone and the AGV zone is underutilized.

Therefore, there is a need for improved methods and systems for allocation of products or SKUs in a warehouse.

### SUMMARY

One aspect of the present disclosure is directed to a computer-implemented system for intelligent allocation of products in a warehouse, the system comprising: a memory storing instructions; and at least one processor configured to execute the instructions to: receive, by a user device, a purchase order comprising at least one product; receive, by a user device, a stock keeping unit (SKU) identifier corresponding to a SKU received in a warehouse, wherein the SKU comprises the at least one product of the purchase order; scan, by a user device, the SKU identifier; determine, based on the scan of the SKU identifier, whether the SKU corresponds to an automated guided vehicle (AGV) zone of the warehouse; when the SKU does not correspond to an AGV zone of the warehouse, command a mobile receptacle to transport the SKU to a manual zone of the warehouse; when the SKU does correspond to an AGV zone of the warehouse: determine whether the SKU identifier comprises a pallet tag, when the SKU identifier comprises a pallet tag: command a mobile receptacle to transport the SKU to an AGV zone of the warehouse, and command an AGV to stow the SKU in the AGV zone of the warehouse; when the SKU identifier does not comprise a pallet tag: calculate a first allocation of the at least one product to be directed to a manual zone of the warehouse and a second allocation of the at least one product to be directed to an AGV zone of the warehouse, command a user device to transport the first allocation of the at least one product to a manual zone, and command an AGV to transport the second allocation of the at least one product to an AGV zone.

Another aspect of the present disclosure is directed to a computer-implemented method for intelligent allocation of products in a warehouse, comprising: receiving, by a user device, a purchase order comprising at least one product; receiving, by a user device, a stock keeping unit (SKU) identifier corresponding to a SKU received in a warehouse, wherein the SKU comprises the at least one product of the purchase order; scanning, by a user device, the SKU identifier; determining, based on the scan of the SKU identifier, whether the SKU corresponds to an automated guided vehicle (AGV) zone of the warehouse; when the SKU does not correspond to an AGV zone of the warehouse, commanding a mobile receptacle to transport the SKU to a manual zone of the warehouse; when the SKU does correspond to an AGV zone of the warehouse: determining whether the SKU identifier comprises a pallet tag, when the SKU identifier comprises a pallet tag: commanding a mobile receptacle to transport the SKU to an AGV zone of the warehouse, and commanding an AGV to stow the SKU in the AGV zone of the warehouse; when the SKU identifier does not comprise a pallet tag: calculating a first allocation of the at least one product to be directed to a manual zone of the warehouse and a second allocation of the at least one product to be directed to an AGV zone of the warehouse, commanding a user device to transport the first allocation of the at least one product to a manual zone, and commanding an AGV to transport the second allocation of the at least one product to an AGV zone.

Yet another aspect of the present disclosure is directed to computer-implemented system for intelligent allocation of products in a warehouse, the system comprising: a memory storing instructions; and at least one processor configured to execute the instructions to: receive, by a user device, a purchase order comprising at least one product; receive, by a user device, a stock keeping unit (SKU) identifier corresponding to a SKU received in a warehouse, wherein the SKU comprises the at least one product of the purchase order; scan, by a user device, the SKU identifier; determine, based on the scan of the SKU identifier, whether the SKU corresponds to an automated guided vehicle (AGV) zone of the warehouse; when the SKU does not correspond to an AGV zone of the warehouse, command a mobile receptacle to transport the SKU to a manual zone of the warehouse; when the SKU does correspond to an AGV zone of the warehouse: determine whether an AGV zone filter is activated, if the AGV zone filter is not activated, then command a mobile receptacle to transport the SKU to a manual zone of the warehouse; if the AGV zone filter is activated, then determine whether the SKU identifier comprises a pallet tag, when the SKU identifier comprises a pallet tag: command a mobile receptacle to transport the SKU to an AGV zone of the warehouse, and command an AGV to stow the SKU in the AGV zone of the warehouse; when the SKU identifier does not comprise a pallet tag: calculate a first allocation of the at least one product to be directed to a manual zone of the warehouse and a second allocation of the at least one product to be directed to an AGV zone of the warehouse, command a user device to transport the first allocation of the at least one product to a manual zone, and command an AGV to transport the second allocation of the at least one product to an AGV zone.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Detail Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a schematic block diagram illustrating an exemplary embodiment of a network comprising computerized systems for product scrapping and product processing, consistent with the disclosed embodiments.

FIG. 4A is a diagram of a process for intelligent allocation of products in a warehouse, consistent with the disclosed embodiments.

FIG. 4B is a diagram of a continuation from FIG. 4A of a process for intelligent allocation of products in a warehouse, consistent with the disclosed embodiments.

FIG. 5 is a diagram of a process for intelligent allocation of products in a warehouse, consistent with the disclosed embodiments.

FIG. 6A is a diagram of a process for intelligent allocation of products in a warehouse, consistent with the disclosed embodiments.

FIG. 6B is a diagram of a continuation from FIG. 6A of a process for intelligent allocation of products in a warehouse, consistent with the disclosed embodiments.

FIG. 7 is a diagram of a process for intelligent allocation of products in a warehouse, consistent with the disclosed embodiments.

FIG. 8 is a schematic diagram illustrating AGVs, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for intelligent allocation of products in a warehouse. In some embodiments, a system may include a memory storing instructions; and at least one processor configured to execute the instructions to: receive, by a user device, a purchase order comprising at least one product; receive, by a user device, a stock keeping unit (SKU) identifier corresponding to a SKU received in a warehouse, wherein the SKU comprises the at least one product of the purchase order; scan, by a user device, the SKU identifier; determine, based on the scan of the SKU identifier, whether the SKU corresponds to an automated guided vehicle (AGV) zone of the warehouse; when the SKU does not correspond to an AGV zone of the warehouse, command a mobile receptacle to transport the SKU to a manual zone of the warehouse; when the SKU does correspond to an AGV zone of the warehouse: determine whether the SKU identifier comprises a pallet tag, when the SKU identifier comprises a pallet tag: command a mobile receptacle to transport the SKU to an AGV zone of the warehouse, and command an AGV to stow the SKU in the AGV zone of the warehouse; when the SKU identifier does not comprise a pallet tag: calculate a first allocation of the at least one product to be directed to a manual zone of the warehouse and a second allocation of the at least one product to be directed to an AGV zone of the warehouse, command a user device to transport the first allocation of the at least one product to a manual zone, and command an AGV to transport the second allocation of the at least one product to an AGV zone.

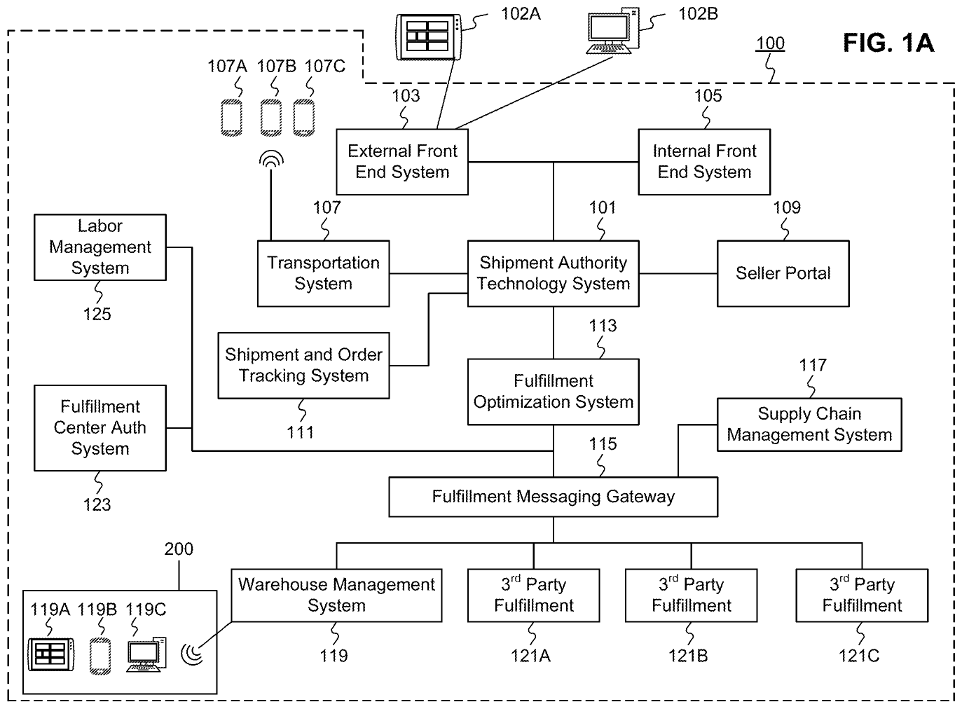

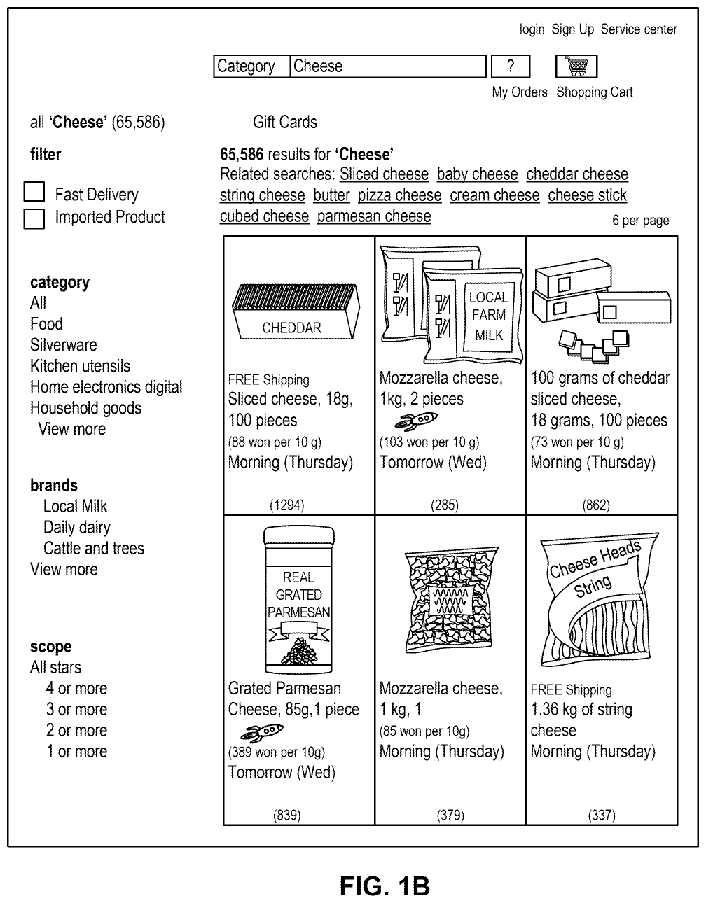

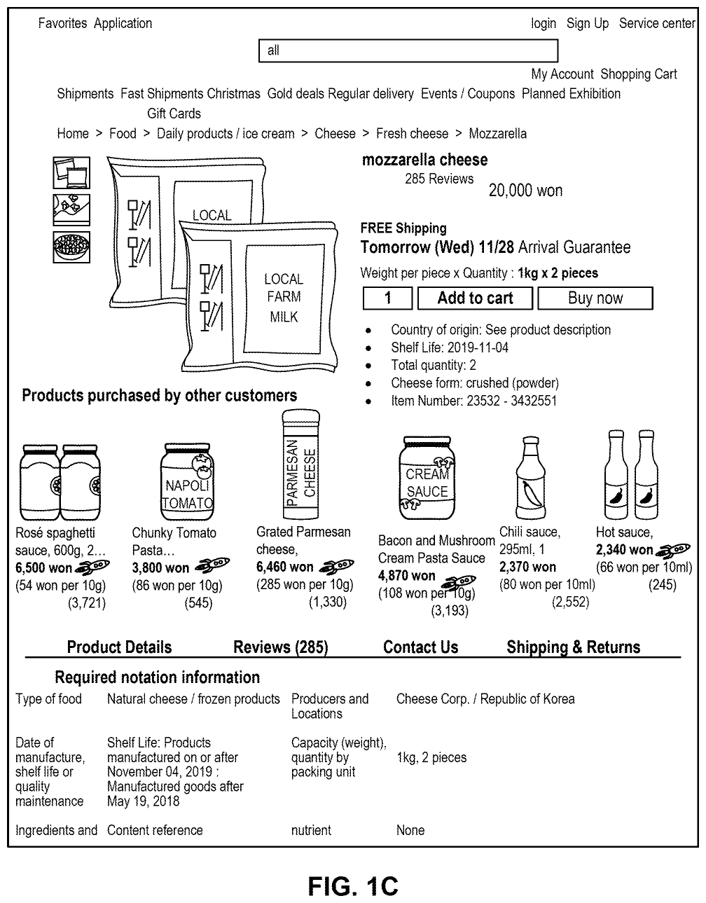

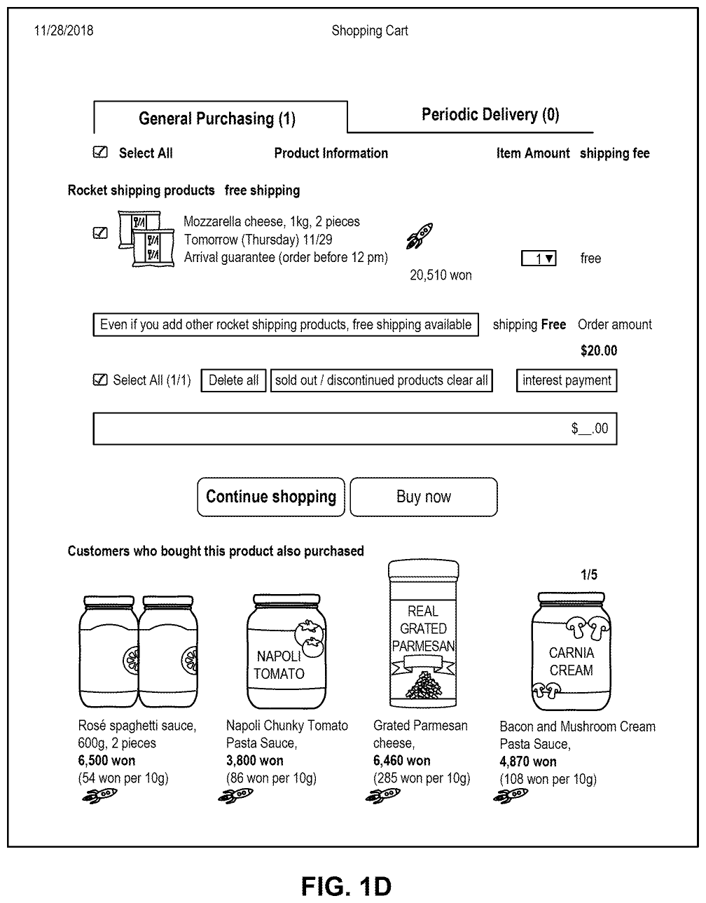

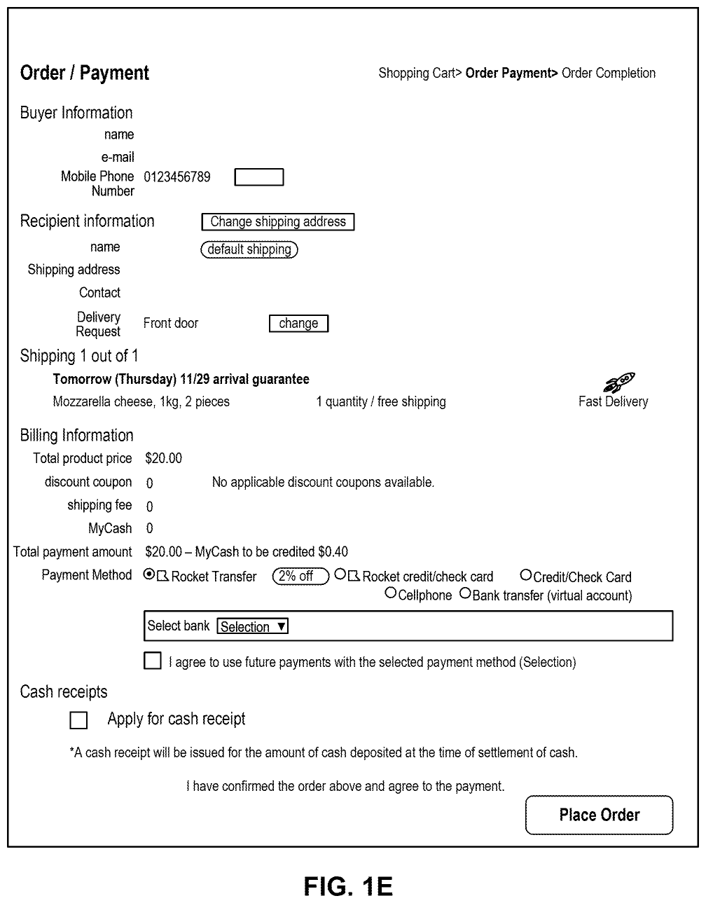

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count of products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

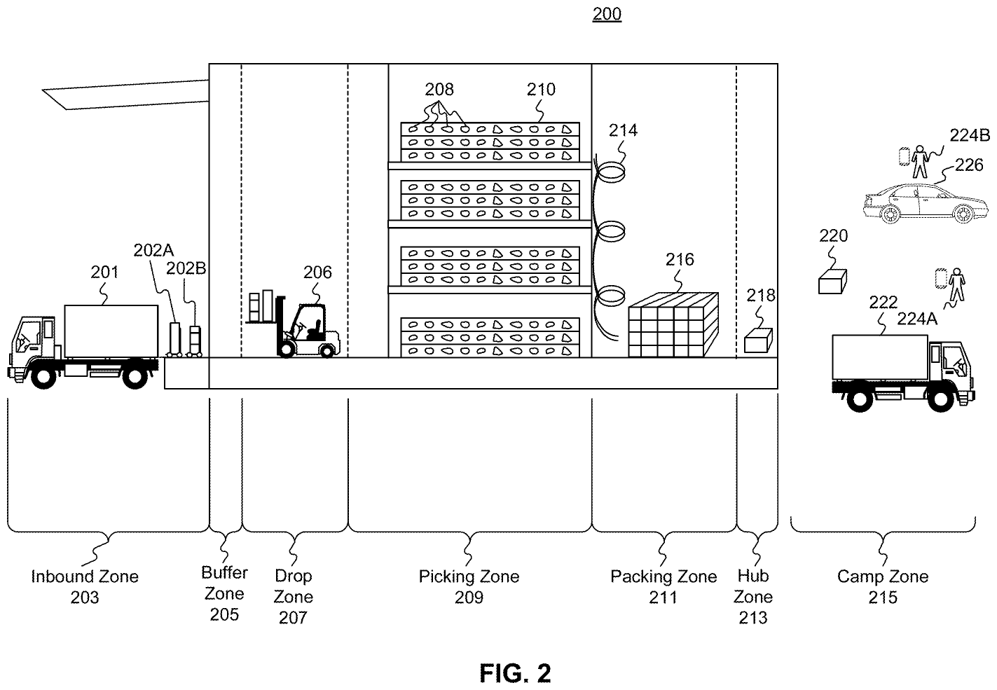

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 119B.

Once a user places an order, a picker may receive an instruction on device 119B to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

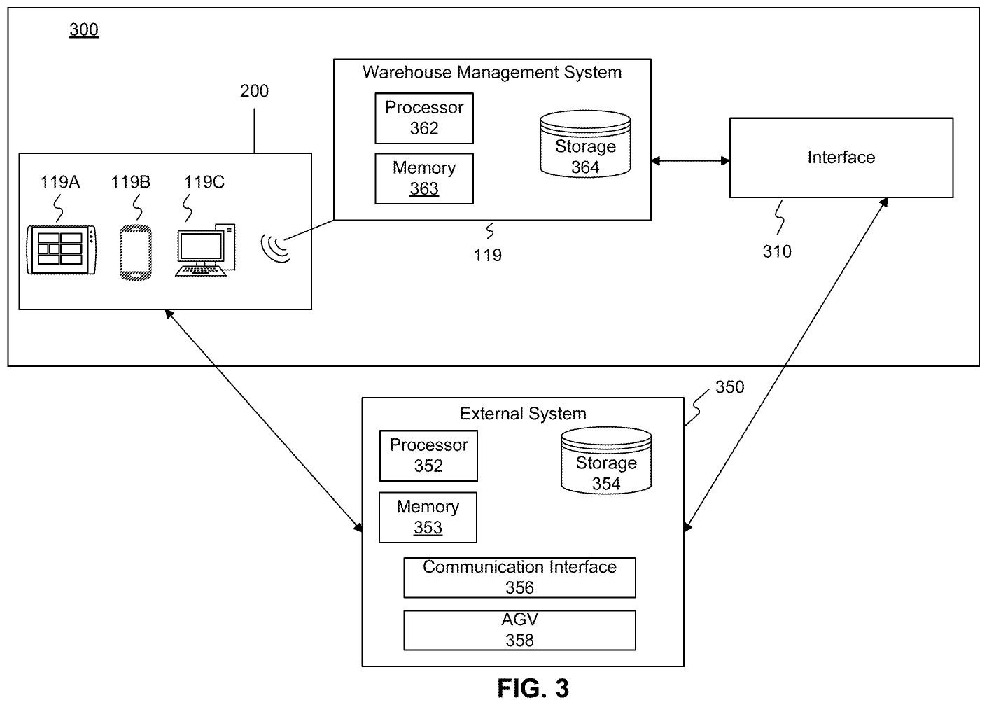

FIG. 3 is a schematic block diagram illustrating an exemplary embodiment of a network comprising computerized systems for product scrapping and product processing, consistent with the disclosed embodiments.

As shown in FIG. 3, a system 300 may include FC 200 (e.g., FC 200 of FIG. 1A, FIG. 2), WMS 119 (e.g., WMS 119 of FIG. 1A), and an interface 310 (e.g., middleware, application programming interface (API), web servers, hardware integration platform, automated robotics platform, etc.). In some embodiments, FC 200 may include mobile devices 119A, 119B, and 119C (e.g., mobile devices 119A, 119B, and 119C of FIG. 1A). In some embodiments, FC 200 may include one or more manual zones and one or more AGV zones. In some embodiments, a manual zone may correspond to an area of FC 200 where SKUs are processed (e.g., placed, moved, and/or tracked) by at least one operator. In some embodiments, an AGV zone of FC 200 may correspond to an area of FC 200 where SKUs are processed by at least one AGV.

In some embodiments, mobile devices 119A, 119B, and 119C may be a tablet, mobile device, computer, or the like. Mobile devices 119A, 119B, and 119C may include a display. The display may include, for example, liquid crystal displays (LCD), light emitting diode screens (LED), organic light emitting diode screens (OLED), a touch screen, and other known display devices. The display may show various information to a user. For example, it may display a user interface element, which includes an option to scan an indicia (e.g., a barcode, an expiration date of a product or SKU, a manufacturing date of a product or SKU, an image, a text string, an RFID tag, or the like) of a product (e.g., items 202A or 202B of FIG. 2) or SKU during processor 400, 500 or 600. Mobile devices 119A, 119B, and 119C may include one or more input/output (I/O) devices. The I/O devices may include one or more devices that allow an operator to send and receive information from mobile devices 119A, 119B, and 119C or another device. The I/O devices may include various input/output devices, a camera, a microphone, a keyboard, a mouse-type device, a gesture sensor, an action sensor, a physical button, an oratory input, etc. The I/O devices may also include one or more communication modules (not shown) for sending and receiving information from system 300 by, for example, establishing wired or wireless connectivity between mobile devices 119A, 119B, or 119C and WMS 119, interface 310, or external system 350.

In some embodiments, WMS 119 may include a processor 362, a memory 363, and a data structure storage 364.

Processor 362 may be one or more known processing devices, such as a microprocessor from the Pentium™ family manufactured by Intel™ or the Turion™ family manufactured by AMD™. Processor 362 may constitute a single core or multiple core processor that executes parallel processes simultaneously. For example, processor 362 may use logical processors to simultaneously execute and control multiple processes. Processor 362 may implement virtual machine technologies or other known technologies to provide the ability to execute, control, run, manipulate, store, etc. multiple software processes, applications, programs, etc. In another example, processor 362 may include a multiple-core processor arrangement configured to provide parallel processing functionalities to allow WMS 119 to execute multiple processes simultaneously. One of ordinary skill in the art would understand that other types of processor arrangements could be implemented that provide for the capabilities disclosed herein.

Memory 363 may store one or more operating systems that perform known operating system functions when executed by processor 362. By way of example, the operating system may include Microsoft Windows, Unix, Linux, Android, Mac OS, iOS, or other types of operating systems. Accordingly, examples of the disclosed invention may operate and function with computer systems running any type of operating system. Memory 363 may be a volatile or non-volatile, magnetic, semiconductor, tape, optical, removable, non-removable, or other type of storage device or tangible computer readable medium.

Data structure storage 364 may include, for example, Oracle™ databases, Sybase™ databases, or other relational databases or non-relational databases, such as Hadoop™ sequence files, HBase™, or Cassandra™. Data structure storage 364 may include computing components (e.g., database management system, database server, etc.) configured to receive and process requests for data stored in memory devices of the database(s) and to provide data from the database(s). Data structure storage 364 may include NoSQL databases such as HBase, MongoDB™ or Cassandra™. Alternatively, data structure storage 364 may include relational databases such as Oracle, MySQL and Microsoft SQL Server. In some embodiments, data structure storage 364 may take the form of servers, general purpose computers, mainframe computers, or any combination of these components.

Data structure storage 364 may store data that may be used by processor 362, respectively, for performing methods and processes associated with disclosed examples. Data structure storage 364 may be located in WMS 119 as shown in FIG. 3, or alternatively, it may be in external storage devices located outside of WMS 119. Data stored in data structure storage 364 may include any suitable data associated with products or SKUs (e.g., SKU identifiers, product identifiers, expiration dates of products or SKUs, manufacturing dates of products or SKUs, sellable or unsellable status of products or SKUs, prices of products, discounted prices of products, inventory status of products or SKUs, etc.).

In some embodiments, WMS 119 may not manage the location of its products or SKUs in FC 200. That is, components of system 300 (e.g., WMS 119, interface 310, mobile devices 119A, 119B, or 119C, etc.) may be unable to determine any location identifiers associated with any SKUs in FC 200. In some embodiments, data storage structure 364 and data storage structure 354 are independent of each other (e.g., there is no communication link between these structures). Instead, WMS 119 may eliminate the need to maintain or track the location of different products or SKUs by offloading this role onto an external system 350. In some embodiments, WMS 119 may communicate with external system 350 via interface 310 (e.g., middleware).

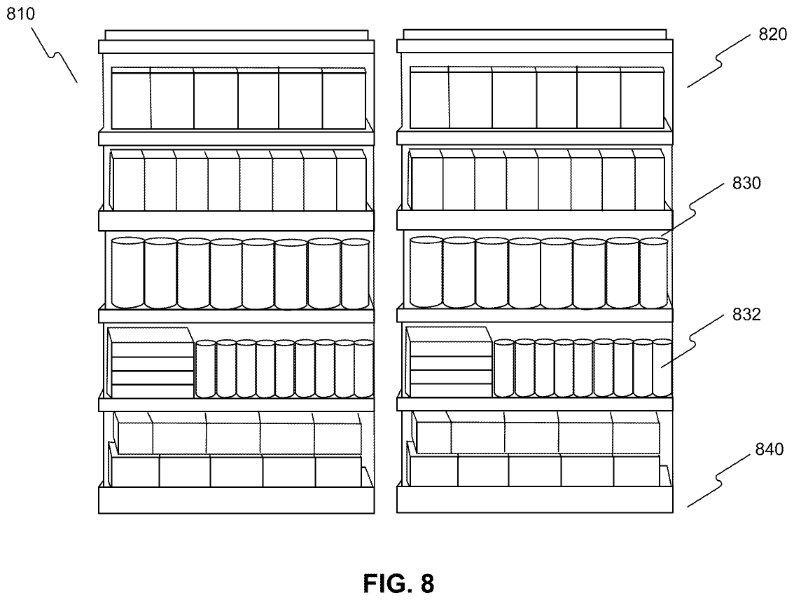

In some embodiments, external system 350 may include a processor 352, a memory 353, a data structure storage 354, a communication interface 356 (e.g., to communicate between external system 350 and interface 310), and at least one automated guided vehicle (AGV) (e.g., AGVs 810 or 820 of FIG. 8).

Processor 352 may be one or more known processing devices, such as a microprocessor from the Pentium™ family manufactured by Intel™ or the Turion™ family manufactured by AMD™. Processor 352 may constitute a single core or multiple core processor that executes parallel processes simultaneously. For example, processor 352 may use logical processors to simultaneously execute and control multiple processes. Processor 352 may implement virtual machine technologies or other known technologies to provide the ability to execute, control, run, manipulate, store, etc. multiple software processes, applications, programs, etc. In another example, processor 352 may include a multiple-core processor arrangement configured to provide parallel processing functionalities to allow one or more AGVs or other components of external system 350 to execute multiple processes simultaneously. One of ordinary skill in the art would understand that other types of processor arrangements could be implemented that provide for the capabilities disclosed herein.

Memory 353 may store one or more operating systems that perform known operating system functions when executed by processor 352. By way of example, the operating system may include Microsoft Windows, Unix, Linux, Android, Mac OS, iOS, or other types of operating systems. Accordingly, examples of the disclosed invention may operate and function with computer systems running any type of operating system. Memory 353 may be a volatile or non-volatile, magnetic, semiconductor, tape, optical, removable, non-removable, or other type of storage device or tangible computer readable medium.

Data structure storage 354 may include, for example, Oracle™ databases, Sybase™ databases, or other relational databases or non-relational databases, such as Hadoop™ sequence files, HBase™, or Cassandra™. Data structure storage 354 may include computing components (e.g., database management system, database server, etc.) configured to receive and process requests for data stored in memory devices of the database(s) and to provide data from the database(s). Data structure storage 354 may include NoSQL databases such as HBase, MongoDB™ or Cassandra™. Alternatively, data structure storage 354 may include relational databases such as Oracle, MySQL and Microsoft SQL Server. In some embodiments, data structure storage 354 may take the form of servers, general purpose computers, mainframe computers, or any combination of these components.

Data structure storage 354 may store data that may be used by processor 352, respectively, for performing methods and processes associated with disclosed examples. Data structure storage 354 may be located in external system 350 as shown in FIG. 3, or alternatively, it may be in external storage devices located outside of external system 350. Data stored in data structure storage 354 may include any suitable data associated with products or SKUs (e.g., SKU identifiers, product identifiers, expiration dates of products or SKUs, manufacturing dates of products or SKUs, sellable or unsellable status of products or SKUs, prices of products, discounted prices of products, inventory status of products or SKUs, etc.).

AGVs may include “shelves” or “bins” (e.g., shelves or bins 830 of FIG. 8) that may carry and transport one or more SKUs of products (e.g., products 832 of FIG. 8). AGVs may traverse a certain area or zone of FC 200 that is separate from the areas or zones occupied by operators or mobile devices 119A, 119B, and 119C. Advantageously, AGVs may transport various SKUs of products from storage in FC 200 to one or more terminals of FC 200, where operators or mobile devices may access the SKUs at these one or more terminals. That is, operators or mobile devices may remain stationary at one or more terminals while AGVs transport SKUs in FC 200 between storage units and terminals.

Advantageously, external system 350 may allow for more efficient storage of products or SKUs in FC 200 because the inventory does not need to be catalogued or stored in shelving in any particular manner that is accessible to operators. That is, throughput and efficiency of FC 200 may increase due to the fact that WMS 119 does not manage the location of its products or SKUs in FC 200.

In some embodiments, system 300 or components thereof (e.g., WMS 119, interface 310, mobile devices 119A-119C, or external system 350) may perform one or more steps of processes 400, 500, 600, or 700 described below.

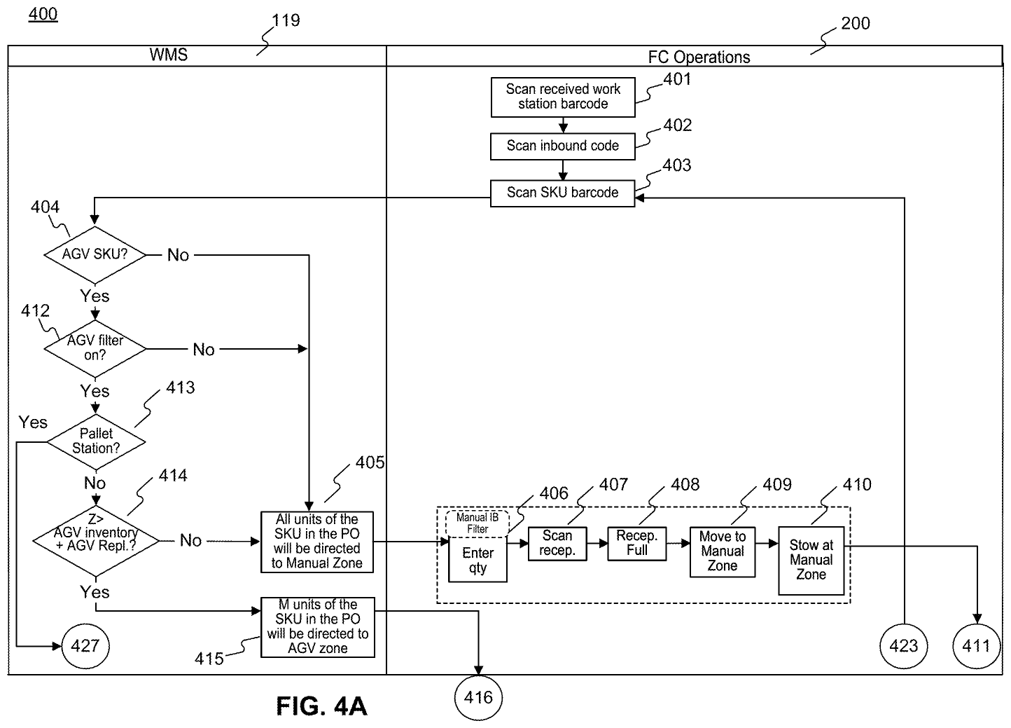

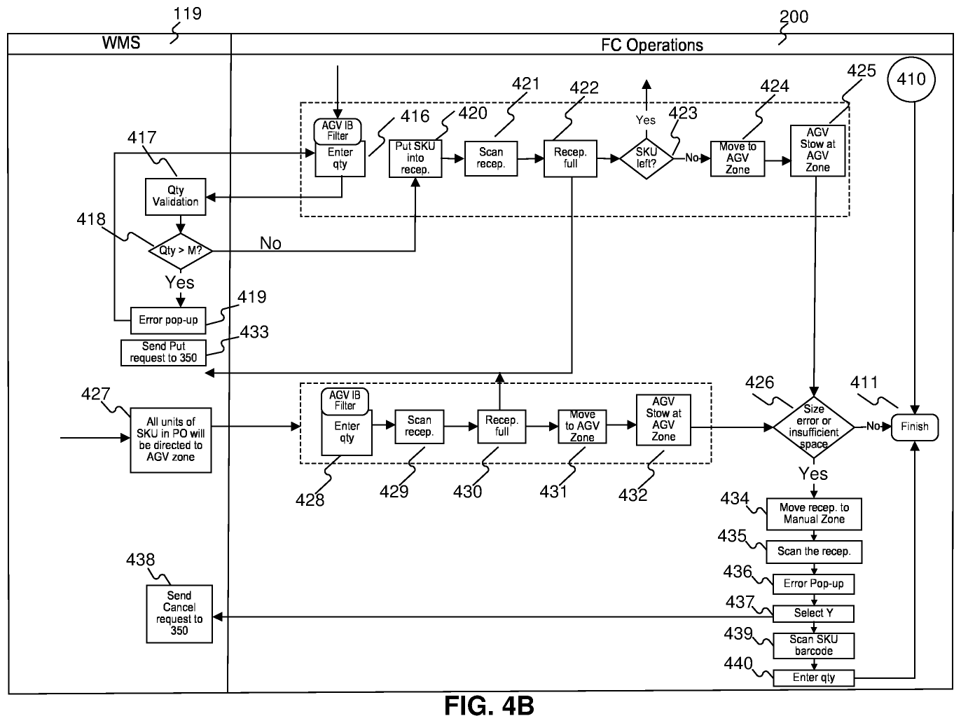

FIG. 4A is a diagram of a process 400 for intelligent allocation of products in a warehouse (e.g., FC 200), consistent with the disclosed embodiments.

In some embodiments, a user device (e.g., of system 300 of FIG. 3 or another component of FIG. 3) may receive a purchase order (PO) including at least one product.

At step 401, at least one user device (e.g., mobile devices 119A, 119B, and 119C of FIG. 1A or FIG. 3) of FC 200 may scan a received work station identifier (e.g., barcode). For example, a received work station identifier may be associated with a terminal or work station that receives SKUs or products at FC 200. In some embodiments, a system of FC 200 may cause a user device to display an instruction for performing this step.

At step 402, at least one user device of FC 200 may scan an inbound (IB) identifier (e.g., an IB barcode). For example, an IB identifier may be associated with an inbound arrival at FC 200 of one or more SKUs. In some embodiments, a system of FC 200 may cause a user device to display an instruction for performing this step.

At step 403, at least one user device of FC 200 may receive and scan a SKU identifier (e.g., SKU barcode). In some embodiments, a SKU identifier may indicate an association with a zone in FC 200 (e.g., a manual zone, an AGV zone), a quantity of products having the SKU, an expiration date corresponding to the earliest expiration date of a product having the SKU, a manufacturing date corresponding to the earliest manufacturing date of a product having the SKU, a shelf date of products having the SKU, a time span within which customers may safely consume a product having the SKU, etc. In some embodiments, a SKU may include a plurality of the same products, where some products may have different expiration dates or different manufacturing dates. In some embodiments, a SKU may include at least one product of a PO. In some embodiments, a system of FC 200 may cause a user device to display an instruction for performing these steps.

At step 404, WMS 119 may determine whether the SKU is an AGV SKU. For example, a data structure storage (e.g., of system 300 of FIG. 3) may modify a SKU identifier to include an association with a zone of FC 200 and WMS 119 may determine whether the SKU identifier indicates an association with an AGV zone of FC 200, which in turn may indicate that the SKU has been directed to an AGV zone of FC 200 (e.g., the SKU may correspond to an AGV zone of FC 200).

If the SKU is not an AGV SKU, then at step 405, all of the units (e.g., products) of the SKU corresponding to one or more POs may be directed to a manual zone of FC 200.

At step 406, a system of FC 200 (e.g., system 300 of FIG. 3, or components thereof) may activate a manual IB filter such that the units of the SKU may be directed to a manual zone of FC 200. A user device of FC 200 may enter a quantity of the units that may be directed to a manual zone of FC 200. In some embodiments, a system of FC 200 may cause a user device to display an instruction for performing these steps.

At step 407, a user device of FC 200 may scan a registered mobile receptacle (e.g., a registered tote). In some embodiments, a system of FC 200 may cause a user device to display an instruction for performing this step.

At step 408, a registered mobile receptacle may be filled with the SKU of units to be directed to a manual zone of FC 200. In some embodiments, a system of FC 200 may cause a user device to display an instruction for performing this step.

At step 409, a system of FC 200 (e.g., system 300 of FIG. 3, or components thereof) may command a registered mobile receptacle to transport the SKU of products to a manual zone of FC 200. In some embodiments, a system of FC 200 may cause a user device to display an instruction for performing this step.

At step 410, a user device of FC 200 may stow the SKU in one or more storage units of a manual zone of FC 200. In some embodiments, a system of FC 200 may cause a user device to display an instruction for performing this step.

From step 410, process 400 may finish at step 411 (in FIG. 4B).

Turning back to step 404 of FIG. 4A, if the SKU is an AGV SKU, then at step 412, WMS 119 may determine whether an AGV filter of a system of FC 200 is activated. If an AGV filter is not activated (e.g., by a user device, by a user associated with a user device, etc.), then WMS 119 may proceed to step 405 and continue the steps described above (at step 405, all of the units (e.g., products) of the SKU corresponding to one or more POs may be directed to a manual zone of FC 200, and a mobile receptacle may be commanded to transport the SKU to a manual zone of FC 200).

If an AGV filter is activated (e.g., by a user device, by a user associated with a user device, etc.), then at step 413, WMS 119 may determine whether the SKU is at a pallet station (e.g., the corresponding SKU identifier may include a pallet tag to indicate that the SKU is at a pallet station). In some embodiments, a pallet station may correspond to a station with SKUs that have a high processing rate (e.g., SKUs with an increased rate of turnover in FC 200). That is, a pallet station may correspond to SKUs that are sold quickly (e.g., an increased rate of turnover in FC 200 may correspond to high demand, to an increased demand in at least one product of the SKU, etc.).

If the SKU is not at a pallet station (e.g., when the SKU identifier does not include a pallet tag), then at step 414, WMS 119 may determine whether “Z” is greater than a sum of the current inventory in a corresponding AGV zone and a replenishment product inventory rate (e.g., a number or rate of SKUs or products to be received by or stored in the AGV zone) of the corresponding AGV zone. In some embodiments, WMS 119 may determine Z, the current inventory in a corresponding AGV zone, and a replenishment product inventory rate of the corresponding AGV zone to determine an allocation of units of the corresponding SKU to be directed to the corresponding AGV zone. In some embodiments, the allocation of units directed to the AGV zone may be calculated to maximize a utilization of the AGV zone. Z may correspond to a capacity of the corresponding AGV zone (e.g., a number SKUs or products that may be held or stored in the AGV zone). In some embodiments, WMS 119 may calculate a replenishment product inventory rate (and consequently Z) based on one or more of the following factors: a quantity of the corresponding SKUs sold, a quantity of the corresponding SKUs received in FC 200, a demand of the SKUs or products, a rate at which the corresponding SKU is received by FC 200 or sold, a condition of the SKUs or products (e.g., how aged a SKU or product is, how damaged or defective a SKU or product is, etc.), a length of the SKU, a weight of the SKU, a volume of the SKU, a storage temperature range of the SKU, a fragileness or fragility of the SKU, etc.

If Z is greater than a sum of the current inventory in a corresponding AGV zone and a replenishment product inventory rate of the corresponding AGV zone (e.g., if the corresponding AGV zone available space for receiving the SKU and its products), then at step 415, WMS 119 may direct up to “M” units of the SKU corresponding to the PO to the AGV zone of FC 200. M may be calculated by calculating the difference between Z and the sum of the current inventory in a corresponding AGV zone and a replenishment product inventory rate of the corresponding AGV zone.

FIG. 4B is a diagram of a continuation from FIG. 4A of process 400 for intelligent allocation of products in a warehouse, consistent with the disclosed embodiments.

At step 416 of FIG. 4B, a user device of FC 200 may enter a quantity of units from the SKU to be directed to an AGV zone of FC 200. In some embodiments, a system of FC 200 may cause a user device to display an instruction for performing these steps.

At step 417, WMS 119 may perform a quantity validation on the entered quantity of units from step 416.

At step 418, WMS 119 may determine whether the entered quantity from step 416 is greater than M.

If the entered quantity is greater than M, then at step 419, WMS 119 may generate an error pop-up indicating that the entered quantity of units may not all be directed to the AGV zone. Steps 416-419 may be repeated until the entered quantity of units is less than or equal to M.

When the entered quantity of units is less than or equal to M, at step 420, a user device of FC 200 may put the SKU with the units into a mobile receptacle (e.g., tote). In some embodiments, a system of FC 200 may cause a user device to display an instruction for performing these steps.

At step 421, a user device of FC 200 may scan the mobile receptacle. In some embodiments, a system of FC 200 may cause a user device to display an instruction for performing this step.

At step 422, a user device of FC 200 may fill the mobile receptacle with the units of the SKU. In some embodiments, a system of FC 200 may cause a user device to display an instruction for performing this step.

At step 423, a user device of FC 200 may determine whether there are any SKUs left to evaluate and allocate at the inbound of FC 200. If yes, then process 400 may turn back to step 403 of FIG. 4A and repeat the steps described above.

If there are no more SKUs to evaluate and allocate, then at step 424 (e.g., via interface 310 of FIG. 3), an external system (e.g., external system 350 of FIG. 3) may command at least one AGV to transport the entered quantity (e.g., the allocation of the products of the SKU) to the AGV zone. For example, external system may send one or more commands over a wireless network to the at least one AGV, causing it to move from one place to another.

At step 425 (e.g., via interface 310 of FIG. 3), an external system may command at least one AGV to transport the SKU to the AGV zone and stow the SKUs.

At step 426, a user device of FC 200 may determine whether a size error of the SKU exists or whether there is insufficient space in the AGV zone for the SKU. In some embodiments, size errors of the SKU may include a SKU having dimensions that are inconsistent (e.g., the SKU is large or too small) with the available capacity. In some embodiments, insufficient space may include a zone of FC 200 being limited in, or not having enough, available capacity in a zone to fit the corresponding SKU. In some embodiments, this step and other steps of process 400 may be performed by other devices or components associated with FC 200 (e.g., other components of system 300 of FIG. 3). If not, then process 400 may proceed to finish at step 411.

Turning back to step 413 of FIG. 4A, if the SKU is at a pallet station, then at step 427 of FIG. 4B, WMS 119 may direct all of the units of the SKU corresponding to the PO to the AGV zone of FC 200.

At step 428, a user device of FC 200 may activate an AGV IB filter and enter a quantity of units from the SKU to be directed to an AGV zone of FC 200. In some embodiments, a system of FC 200 may cause a user device to display an instruction for performing these steps.

At step 429, a user device of FC 200 may scan the mobile receptacle. In some embodiments, a system of FC 200 may cause a user device to display an instruction for performing this step.

At step 430, a user device of FC 200 may fill the mobile receptacle with the units of the SKU. In some embodiments, a system of FC 200 may cause a user device to display an instruction for performing this step.

At step 431 (e.g., via interface 310 of FIG. 3), an external system (e.g., external system 350 of FIG. 3) may command at least one AGV to transport the entered quantity (e.g., the products of the SKU) to the AGV zone.

At step 432 (e.g., via interface 310 of FIG. 3), an external system may command at least one AGV to transport the SKU to the AGV zone and stow the SKUs. From step 432, process 400 may proceed to step 426 and repeat the steps described above.

From step 422 or step 430, at step 433, when a mobile receptacle is full, a user device of FC 200 may send a put request to WMS 119, which may transmit the request to the external system (e.g., external system 350 of FIG. 3) via an interface (e.g., interface 310 of FIG. 3). In response to receiving the request, the external system may command at least one AGV to put the SKU and units into storage units of the AGV zone.

Turning back to step 426, if a size error exists or if there is insufficient space in the AGV zone for the SKU, then at step 434, a user device of FC 200 may command at least one mobile receptacle to move to a manual zone. In some embodiments, a system of FC 200 may cause a user device to display an instruction for performing this step.

At step 435, a user device of FC 200 may scan the mobile receptacle. In some embodiments, a system of FC 200 may cause a user device to display an instruction for performing this step.

At step 436, a user device of FC 200 may generate an error pop-up indicating that a size error exists or that there is insufficient space in the AGV zone for the SKU.

At step 437, a user device of FC 200 may select “Y” units, which may correspond to the number of units from the SKU that exceed the available capacity of the AGV zone. In some embodiments, a system of FC 200 may cause a user device to display an instruction for performing this step.

At step 438, a user device of FC 200 may transmit a cancel request to WMS 119, which may transmit the request to an external system (e.g., external system 350 of FIG. 3) via an interface (e.g., interface 310 of FIG. 3). The cancel request may cancel a put request for putting Y units of the SKU into storage units in the AGV zone.

At step 439, a user device of FC 200 may scan the SKU identifier. In some embodiments, a system of FC 200 may cause a user device to display an instruction for performing this step.

At step 440, a user device of FC 200 may enter a quantity of units of the SKU to put in the AGV zone and proceed to finish at step 411. In some embodiments, a system of FC 200 may cause a user device to display an instruction for performing this step.

Advantageously, process 400 may allow a system (e.g., system 300 of FIG. 3) to set conditions for which SKUs may be stowed in the AGV zone such that a SKU that meets the set conditions may be automatically registered as an AGV SKU. Moreover, the system may periodically (e.g., every 24 hours, every 12 hours, etc.) identify whether a change has occurred in the AGV SKU conditions and automatically release the SKU if any change is found. In some embodiments, the system may change the setting if there remains inventory in the AGV zone to avoid further stowing in the AGV zone and automatically release the SKU after the inventory is exhausted.

By periodically monitoring the moving parts of a FC, the system may implement a feedback loop based on a zone's space utilization, inbound/outbound volume achieved compared to the maximum capacity of the zone, the zone's stowing cycle time, etc. and adjust parameters of the system to cause the process flow to change in a way that increases space utilization, efficiency, throughput, and profits.

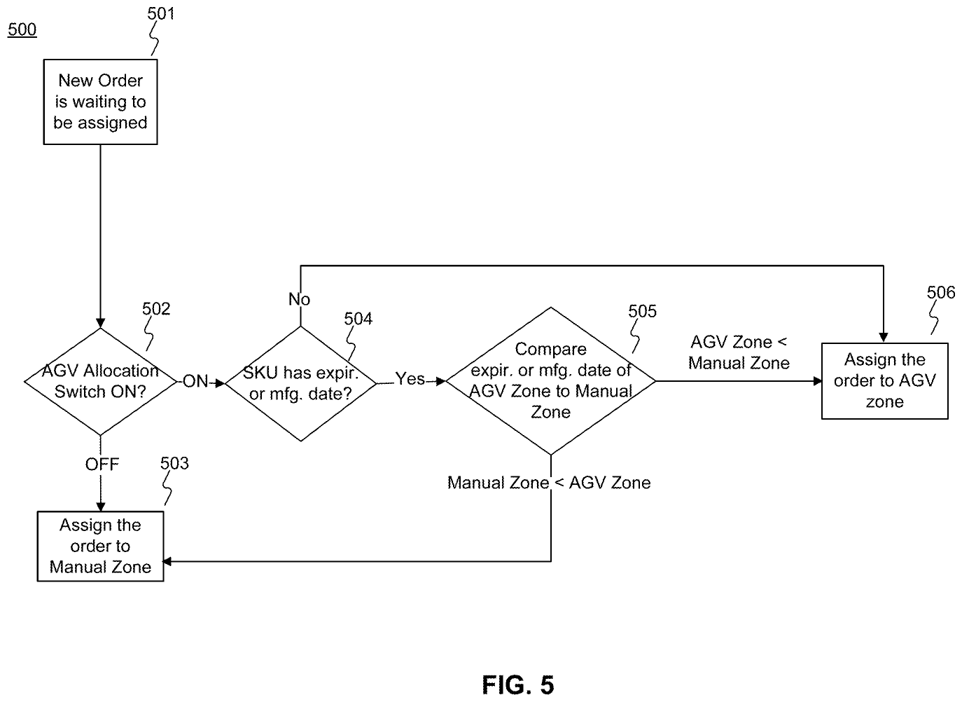

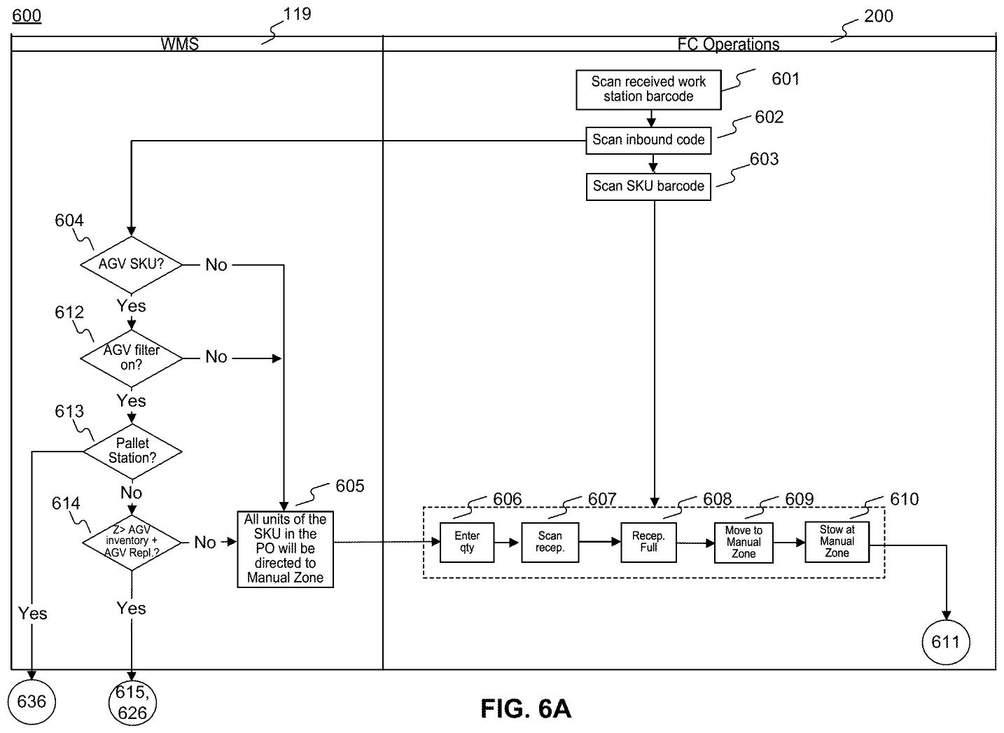

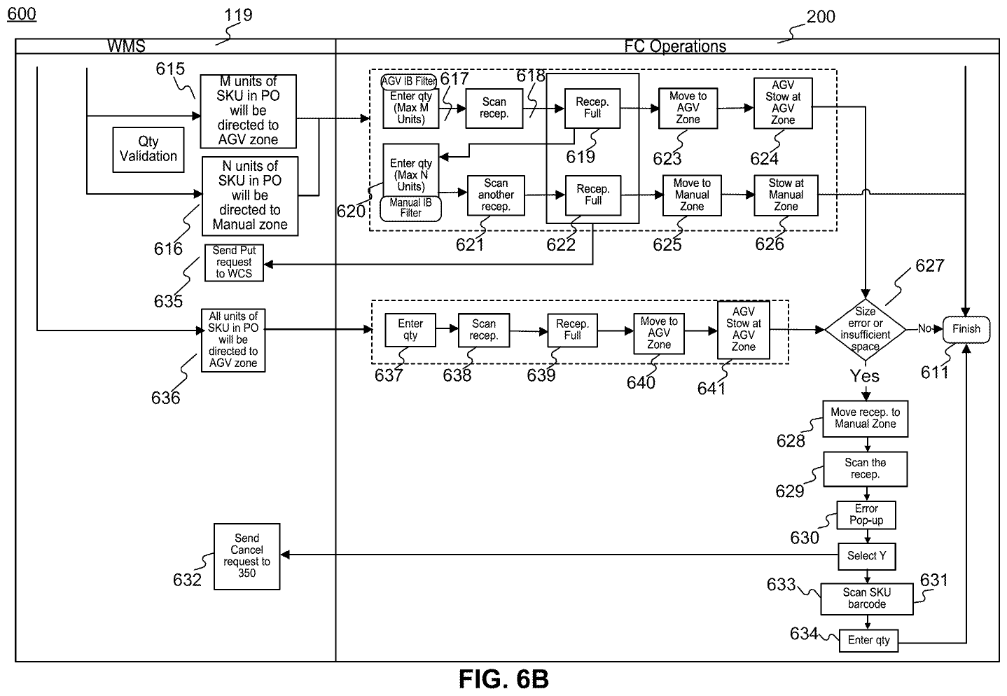

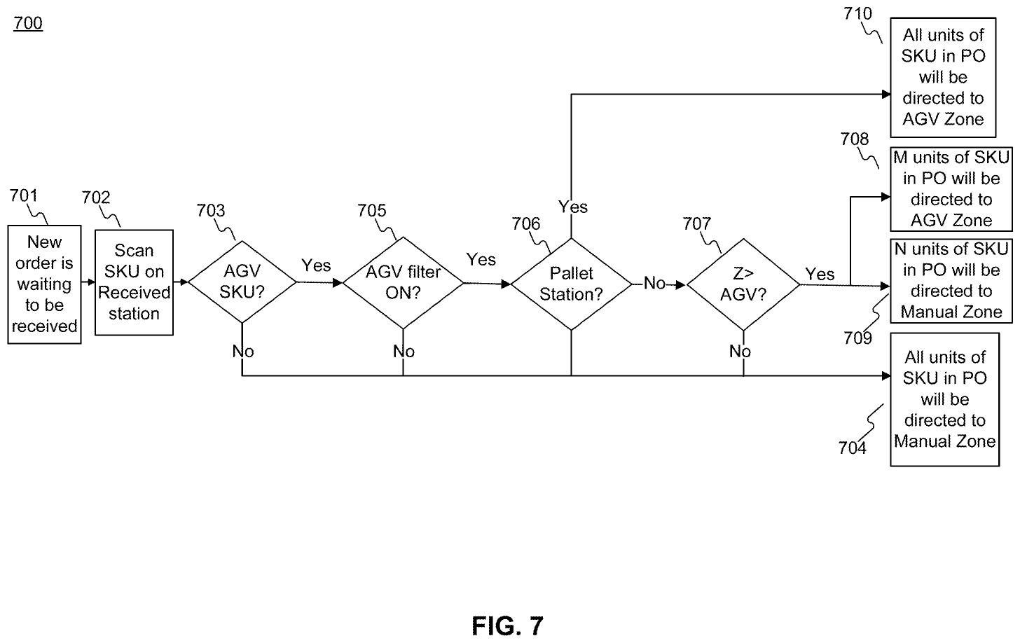

FIG. 5 is a diagram of a process 500 for intelligent allocation of products in a warehouse (e.g., FC 200), consistent with the disclosed embodiments. It should be understood that in some embodiments, process 500 may continue from and continue to steps of process 400 of FIGS. 4A-4B, process 600 of FIGS. 6A-6B, or process 700 of FIG. 7.

In some embodiments, a user device (e.g., of system 300 of FIG. 3 or another component of FIG. 3) may receive a purchase order (PO) including at least one product.

At step 501, a new PO may be waiting at FC 200 to be assigned. For example, the SKUs corresponding to the PO may be waiting to be allocated to a zone of FC 200.

At step 502, WMS 119 may determine whether an AGV allocation switch (e.g., AGV zone filter) is activated. In some embodiments, an AGV allocation switch may be set by a system (e.g., system 300 of FIG. 3, or components thereof) of FC 200. In some embodiments, FC 200 may turn the AGV allocation switch on or off to increase inbound efficiency or outbound efficiency based on the POs and items in the POs, and to maximize utilization of the zones of FC 200. In some embodiments, a PO may be allocated to the AGV zone, but a customer order cancellation may occur because the picking of the items in a FC cannot be completed in time. In such cases, the AGV zone allocation logic may be adjusted to ensure that no additional orders are allocated to the AGV zone (e.g., the AGV allocation switch may be disabled).

If the AGV allocation switch is off (e.g., not activated), then at step 503, WMS 119 may assign (e.g., allocate) the SKU of the PO to a manual zone of FC 200. In some embodiments, the AGV allocation switch being deactivated may correspond to an indication that FC 200 is diverting items from AGV zone. FC 200 may divert items from the AGV zone when the AGV zone is near or at full capacity and a manual zone has available capacity. In some embodiments, process 500 can proceed from step 503 to follow steps similar to process 400 of FIGS. 4A-4B (e.g., steps 406-411) or process 600 of FIGS. 6A-6B (e.g., steps 611, 617-635).

Turning back to step 502, if the AGV allocation switch is on (e.g., activated), then at step 504, WMS 119 may determine whether a SKU identifier of the SKU has a corresponding expiration date or manufacturing date (e.g., of a product of the SKU).

If not, then at step 506, the SKU may be assigned (e.g., allocated) to the AGV zone. In some embodiments, process 500 may proceed from step 506 to steps similar to process 400 of FIGS. 4A-4B (e.g., steps 411, 416-440) or process 600 of FIGS. 6A-6B (e.g., steps 611, 617-641).

Turning back to step 504, if the SKU identifier has a corresponding expiration date or manufacturing date, then at step 505, WMS 119 may compare at least one of an expiration date or a manufacturing date of the AGV zone (e.g., an AGV zone identifier) to at least one of an expiration date or a manufacturing date of the manual zone (e.g., a manual zone identifier) (e.g., different zones may have different expiration or manufacturing dates it may accommodate due to the size of the zones in FC 200, the temperature or humidity of the zones in FC 200, etc.).

If an expiration date or a manufacturing date of the manual zone is earlier than an expiration date or a manufacturing date of the AGV zone, then process 500 may proceed to step 503 and assign the SKU (e.g., its products) of the PO to the manual zone. Advantageously, process 500 may increase throughput in the FC since the manual zone may receive and process certain SKUs faster than the AGV zone since the manual zone may be able to accommodate earlier expiration or manufacturing dates.

If an expiration date or a manufacturing date of the AGV zone is earlier than an expiration date or a manufacturing date of the manual zone, then at step 506, WMS 119 may assign (e.g., allocate) the SKU (e.g., its products) of the PO to the AGV zone. In some embodiments, process 500 may proceed from step 506 to steps similar to process 400 of FIGS. 4A-4B (e.g., steps 411, 416-440) or process 600 of FIGS. 6A-6B (e.g., steps 611, 617-641).

In some embodiments, process 500 may advantageously apply a first in first out (FIFO) method to SKUs subject to expiration dates or manufacturing dates to avoid an increase in the manual zone's inventory scrap rate and to prioritize the AGV zone allocation for units that are not subject to expiration dates or manufacturing dates.

FIG. 6A is a diagram of a process 600 for intelligent allocation of products in a warehouse (e.g., FC 200), consistent with the disclosed embodiments.

In some embodiments, a user device (e.g., of system 300 of FIG. 3 or another component of FIG. 3) may receive a PO including at least one product.

At step 601, at least one user device (e.g., mobile devices 119A, 119B, and 119C of FIG. 1A or FIG. 3) of FC 200 may scan a received work station identifier (e.g., barcode). For example, a received work station identifier may be associated with a terminal or work station that receives SKUs or products at FC 200. In some embodiments, a system of FC 200 may cause a user device to display an instruction for performing this step.

At step 602, at least one user device of FC 200 may scan an inbound (IB) identifier (e.g., an IB barcode). For example, an IB identifier may be associated with an inbound arrival at FC 200 of one or more SKUs. In some embodiments, a system of FC 200 may cause a user device to display an instruction for performing this step.

At step 603, at least one user device of FC 200 may receive and scan a SKU identifier (e.g., SKU barcode). In some embodiments, a SKU identifier may indicate an association with a zone in FC 200 (e.g., a manual zone, an AGV zone), a quantity of products having the SKU, an expiration date corresponding to the earliest expiration date of a product having the SKU, a manufacturing date corresponding to the earliest manufacturing date of a product having the SKU, a shelf date of products having the SKU, a time span within which customers may safely consume a product having the SKU, etc. In some embodiments, a SKU may include a plurality of the same products, where some products may have different expiration dates or different manufacturing dates. In some embodiments, a SKU may include at least one product of a PO. In some embodiments, a system of FC 200 may cause a user device to display an instruction for performing these steps.

At step 604, WMS 119 may determine whether the SKU is an AGV SKU. For example, a data structure storage (e.g., of system 300 of FIG. 3) may modify a SKU identifier to include an association with a zone of FC 200 and WMS 119 may determine whether the SKU identifier indicates an association with an AGV zone of FC 200, which in turn may indicate that the SKU has been directed to an AGV zone of FC 200 (e.g., the SKU may correspond to an AGV zone of FC 200).

If the SKU is not an AGV SKU, then at step 605, all of the units (e.g., products) of the SKU corresponding to one or more POs may be directed to a manual zone of FC 200.

At step 606, a user device of FC 200 may enter a quantity of the units that may be directed to a manual zone of FC 200. In some embodiments, a system of FC 200 may cause a user device to display an instruction for performing this step.

At step 607, a user device of FC 200 may scan a registered mobile receptacle (e.g., a registered tote). In some embodiments, a system of FC 200 may cause a user device to display an instruction for performing this step.

At step 608, a registered mobile receptacle may be filled with the SKU of units to be directed to a manual zone of FC 200. In some embodiments, a system of FC 200 may cause a user device to display an instruction for performing this step.

At step 609, a system of FC 200 (e.g., system 300 of FIG. 3, or components thereof) may command a registered mobile receptacle to transport the SKU of products to a manual zone of FC 200. In some embodiments, a system of FC 200 may cause a user device to display an instruction for performing this step.

At step 610, a user device of FC 200 may stow the SKU in one or more storage units of a manual zone of FC 200. In some embodiments, a system of FC 200 may cause a user device to display an instruction for performing this step.

From step 610, process 600 may finish at step 611 (in FIG. 6B).

Turning back to step 604 of FIG. 6A, if the SKU is an AGV SKU, then at step 612, WMS 119 may determine whether an AGV filter of a system of FC 200 is activated. If an AGV filter is not activated (e.g., by a user device, by a user associated with a user device, etc.), then WMS 119 may proceed to step 605 and continue the steps described above (at step 605, all of the units (e.g., products) of the SKU corresponding to one or more POs may be directed to a manual zone of FC 200, and a mobile receptacle may be commanded to transport the SKU to a manual zone of FC 200).

If an AGV filter is activated (e.g., by a user device, by a user associated with a user device, etc.), then at step 613, WMS 119 may determine whether the SKU is at a pallet station (e.g., the corresponding SKU identifier may include a pallet tag to indicate that the SKU is at a pallet station). In some embodiments, a pallet station may correspond to a station with SKUs that have a high processing rate (e.g., SKUs with an increased rate of turnover in FC 200). That is, a pallet station may correspond to SKUs that are sold quickly (e.g., an increased rate of turnover in FC 200 may correspond to high demand, to an increased demand in at least one product of the SKU, etc.).

If the SKU is not at a pallet station (e.g., when the SKU identifier does not include a pallet tag), then at step 614, WMS 119 may determine whether “Z” is greater than a sum of the current inventory in a corresponding AGV zone and a replenishment product inventory rate (e.g., a number or rate of SKUs or products to be received by or stored in the AGV zone) of the corresponding AGV zone. In some embodiments, WMS 119 may determine Z, the current inventory in a corresponding AGV zone, and a replenishment product inventory rate of the corresponding AGV zone to determine an allocation of units of the corresponding SKU to be directed to the corresponding AGV zone and an allocation of units of the corresponding SKU to be directed to a manual zone.

In some embodiments, the allocation of units directed to the AGV zone may be calculated to maximize a utilization of the AGV zone. In some embodiments, the allocation of units directed to the manual zone may be calculated to maximize a utilization of the manual zone. Z may correspond to a capacity of the corresponding AGV zone (e.g., a number SKUs or products that may be held or stored in the AGV zone). In some embodiments, WMS 119 may calculate a replenishment product inventory rate (and consequently Z) based on one or more of the following factors: a quantity of the corresponding SKUs sold, a quantity of the corresponding SKUs received in FC 200, a demand of the SKUs or products, a rate at which the corresponding SKU is received by FC 200 or sold, a condition of the SKUs or products (e.g., how aged a SKU or product is, how damaged or defective a SKU or product is, etc.), a length of the SKU, a weight of the SKU, a volume of the SKU, a storage temperature range of the SKU, a fragileness or fragility of the SKU, etc.

FIG. 6B is a diagram of a continuation from FIG. 6A of process 600 for intelligent allocation of products in a warehouse, consistent with the disclosed embodiments.

If Z is greater than a sum of the current inventory in a corresponding AGV zone and a replenishment product inventory rate of the corresponding AGV zone (e.g., if the corresponding AGV zone available space for receiving the SKU and its products), then at step 615 of FIG. 6B, WMS 119 may direct up to “M” units of the SKU corresponding to the PO to the AGV zone of FC 200. M may be calculated by calculating the difference between Z and the sum of the current inventory in a corresponding AGV zone and a replenishment product inventory rate of the corresponding AGV zone.

From step 614, process 600 may also proceed to step 616. At step 616, WMS 119 may direct up to “N” units of the SKU corresponding to the PO to the manual zone of FC 200. N may be calculated by calculating a number of units of the SKU that exceed (e.g., are in excess of) the available capacity of the AGV zone. In some embodiments, steps 615 and 616 may be performed substantially simultaneously. In some embodiments, steps 615 and 616 may not be performed simultaneously.

At step 615 or step 616, WMS 119 may perform a quantity validation on the quantities of units directed to the AGV zone or the manual zone such that the number of units directed to either zone do not exceed their respective available capacities.

At step 617 of FIG. 6B, a user device of FC 200 may enter a quantity of units from the SKU to be directed to an AGV zone of FC 200. In some embodiments, a system of FC 200 may cause a user device to display an instruction for performing these steps.

At step 618, a user device of FC 200 may scan a first mobile receptacle (e.g., tote). In some embodiments, a system of FC 200 may cause a user device to display an instruction for performing this step.

At step 619, a user device of FC 200 may fill the first mobile receptacle with the units of the SKU to be directed to the AGV zone. In some embodiments, a system of FC 200 may cause a user device to display an instruction for performing these steps.

At step 620, a user device of FC 200 may activate a manual IB filter and enter a quantity of units from the SKU to be directed to a manual zone of FC 200. In some embodiments, a system of FC 200 may cause a user device to display an instruction for performing these steps.

At step 621, a user device of FC 200 may scan a second mobile receptacle. In some embodiments, a system of FC 200 may cause a user device to display an instruction for performing this step.

At step 622, a user device of FC 200 may fill the second mobile receptacle with the units of the SKU to be directed to the manual zone. In some embodiments, a system of FC 200 may cause a user device to display an instruction for performing this step.

In some embodiments, step 619 may proceed to step 623 simultaneously with step 620. At step 623 (e.g., via interface 310 of FIG. 3), an external system (e.g., external system 350 of FIG. 3) may command at least one AGV to transport the first mobile receptacle with the entered quantity (e.g., the allocation of the products of the SKU) to the AGV zone.

At step 624 (e.g., via interface 310 of FIG. 3), an external system may command at least one AGV to transport the units of the SKU to the AGV zone and stow the SKUs or units of the SKUs. For example, external system may send one or more commands over a wireless network to the at least one AGV, causing it to move from one place to another.

At step 625, a user device of FC 200 may command the second mobile receptacle to transport the entered quantity (e.g., the allocation of the products of the SKU) to the manual zone. In some embodiments, a system of FC 200 may cause a user device to display an instruction for performing this step.

At step 626, a user device of FC 200 may command the second mobile receptacle to transport the units of the SKU to the manual zone and stow the SKUs or units of the SKUs. In some embodiments, a system of FC 200 may cause a user device to display an instruction for performing this step.

At step 627, a user device of FC 200 may determine whether a size error of the SKU exists or whether there is insufficient space in the AGV zone for the units of the SKU. In some embodiments, size errors of the SKU may include a SKU having dimensions that are inconsistent (e.g., the SKU is large or too small) with the available capacity. In some embodiments, insufficient space may include a zone of FC 200 being limited in, or not having enough, available capacity in a zone to fit the corresponding SKU. In some embodiments, this step and other steps of process 400 may be performed by other devices or components associated with FC 200 (e.g., other components of system 300 of FIG. 3). If not, then process 600 may proceed to finish at step 611.

If a size error exists or if there is insufficient space in the AGV zone for the SKUs, then at step 628, a user device of FC 200 may command at least one mobile receptacle to move to a manual zone. In some embodiments, a system of FC 200 may cause a user device to display an instruction for performing this step.

At step 629, a user device of FC 200 may scan the mobile receptacle. In some embodiments, a system of FC 200 may cause a user device to display an instruction for performing this step.

At step 630, a user device of FC 200 may generate an error pop-up indicating that a size error exists or that there is insufficient space in the AGV zone for the SKU.

At step 631, a user device of FC 200 may select “Y” units, which may correspond to the number of units from the SKU that exceed the available capacity of the AGV zone. In some embodiments, a system of FC 200 may cause a user device to display an instruction for performing this step.

At step 632, a user device of FC 200 may transmit a cancel request to WMS 119, which may transmit the request to an external system (e.g., external system 350 of FIG. 3) via an interface (e.g., interface 310 of FIG. 3). The cancel request may cancel a put request for putting Y units of the SKU into storage units in the AGV zone.

At step 633, a user device of FC 200 may scan the SKU identifier. In some embodiments, a system of FC 200 may cause a user device to display an instruction for performing this step.

At step 634, a user device of FC 200 may enter a quantity of units of the SKU to put in the AGV zone and a quantity of units of the SKU to put in the manual zone and proceed to finish at step 611. In some embodiments, a system of FC 200 may cause a user device to display an instruction for performing this step.

From steps 619 and 622, at step 635, when the first mobile receptacle is full and the second mobile receptacle is full, a user device may send a put request to WMS 119, which may transmit the request to the external system (e.g., external system 350 of FIG. 3) via an interface (e.g., interface 310 of FIG. 3). In response to receiving the request, the external system may command at least one AGV to put the SKU and units (the units that do not exceed M) into storage units of the AGV zone. In some embodiments, step 622 may proceed to step 635 independently of whether process 600 reaches step 619.

Turning back to step 613 of FIG. 6A, if the SKU is at a pallet station, then at step 636 of FIG. 6B, WMS 119 may direct all of the units of the SKU corresponding to the PO to the AGV zone of FC 200.

At step 637, a user device of FC 200 may enter a quantity of units from the SKU to be directed to an AGV zone of FC 200. In some embodiments, a system of FC 200 may cause a user device to display an instruction for performing these steps.

At step 638, a user device of FC 200 may scan the mobile receptacle. In some embodiments, a system of FC 200 may cause a user device to display an instruction for performing this step.

At step 639, a user device of FC 200 may fill the mobile receptacle with the units of the SKU. In some embodiments, a system of FC 200 may cause a user device to display an instruction for performing this step.

At step 640 (e.g., via interface 310 of FIG. 3), an external system (e.g., external system 350 of FIG. 3) may command at least one AGV to transport the entered quantity (e.g., the products of the SKU) to the AGV zone.

At step 641 (e.g., via interface 310 of FIG. 3), an external system may command at least one AGV to transport the SKU to the AGV zone and stow the SKUs. From step 641, process 400 may proceed to step 627 and repeat the steps described above.

Turning back to step 603, process 600 may proceed from step 603 to step 606 at any point to direct some units of SKUs to the manual zone.

Advantageously, similar to process 400, process 600 may allow a system (e.g., system 300 of FIG. 3) to set conditions for which SKUs may be stowed in the AGV zone such that a SKU that meets the set conditions may be automatically registered as an AGV SKU. Moreover, the system may periodically (e.g., every 24 hours, every 12 hours, etc.) identify whether a change has occurred in the AGV SKU conditions and automatically release the SKU if any change is found. In some embodiments, the system may change the setting if there remains inventory in the AGV zone to avoid further stowing in the AGV zone and automatically release the SKU after the inventory is exhausted.

By periodically monitoring the moving parts of a FC, the system may implement a feedback loop based on a zone's space utilization, inbound/outbound volume achieved compared to the maximum capacity of the zone, the zone's stowing cycle time, etc. and adjust parameters of the system to cause the process flow to change in a way that increases space utilization, efficiency, throughput, and profits.

Advantageously, process 600 may prioritize some units to the manual zone (e.g., to avoid exceeding the maximum available capacity of the AGV zone), which may be adjusted automatically based on the monitoring of capacity levels of different zones in a FC. In some embodiments, exceeding the maximum available capacity of a zone should be avoided to avoid delayed picking of units or lower throughput.

FIG. 7 is a diagram of a process 700 for intelligent allocation of products in a warehouse (e.g., FC 200), consistent with the disclosed embodiments. It should be understood that in some embodiments, process 700 may continue from and continue to steps of process 400 of FIGS. 4A-4B, process 500 of FIG. 5, or process 600 of FIGS. 6A-6B.

In some embodiments, a user device (e.g., of system 300 of FIG. 3 or another component of FIG. 3) may receive a purchase order (PO) including at least one product.

At step 701, a new PO may be waiting at FC 200 to be assigned. For example, the SKUs corresponding to the PO may be waiting to be allocated to a zone of FC 200.

At step 701, at least one user device (e.g., mobile devices 119A, 119B, and 119C of FIG. 1A or FIG. 3) of FC 200 may scan a received work station identifier (e.g., barcode). For example, a received work station identifier may be associated with a terminal or work station that receives SKUs or products at FC 200. In some embodiments, a system of FC 200 may cause a user device to display an instruction for performing this step.

At step 703, WMS 119 may determine whether the SKU is an AGV SKU. For example, a data structure storage (e.g., of system 300 of FIG. 3) may modify a SKU identifier to include an association with a zone of FC 200 and WMS 119 may determine whether the SKU identifier indicates an association with an AGV zone of FC 200, which in turn may indicate that the SKU has been directed to an AGV zone of FC 200 (e.g., the SKU may correspond to an AGV zone of FC 200).

If the SKU is not an AGV SKU, then at step 704, all of the units (e.g., products) having the SKU corresponding to one or more POs may be directed to a manual zone of FC 200.

If the SKU is an AGV SKU, then at step 705, WMS 119 may determine whether an AGV filter of a system of FC 200 is activated. If an AGV filter is not activated (e.g., by a user device, by a user associated with a user device, etc.), then WMS 119 may proceed to step 704 and continue the steps described above (at step 704, all of the units (e.g., products) of the SKU corresponding to one or more POs may be directed to a manual zone of FC 200, and a mobile receptacle may be commanded to transport the SKU to a manual zone of FC 200).

If an AGV filter is activated (e.g., by a user device, by a user associated with a user device, etc.), then at step 706, WMS 119 may determine whether the SKU is at a pallet station (e.g., the corresponding SKU identifier may include a pallet tag to indicate that the SKU is at a pallet station). In some embodiments, a pallet station may correspond to a station with SKUs that have a high processing rate (e.g., SKUs with an increased rate of turnover in FC 200). That is, a pallet station may correspond to SKUs that are sold quickly (e.g., an increased rate of turnover in FC 200 may correspond to high demand, to an increased demand in at least one product of the SKU, etc.).

If the SKU is not at a pallet station (e.g., when the SKU identifier does not include a pallet tag), then at step 707, WMS 119 may determine whether “Z” is greater than a sum of the current inventory in a corresponding AGV zone and a replenishment product inventory rate (e.g., a number or rate of SKUs or products to be received by or stored in the AGV zone) of the corresponding AGV zone. In some embodiments, WMS 119 may determine Z, the current inventory in a corresponding AGV zone, and a replenishment product inventory rate of the corresponding AGV zone to determine an allocation of units of the corresponding SKU to be directed to the corresponding AGV zone and an allocation of units of the corresponding SKU to be directed to a manual zone.

In some embodiments, the allocation of units directed to the AGV zone may be calculated to maximize a utilization of the AGV zone. In some embodiments, the allocation of units directed to the manual zone may be calculated to maximize a utilization of the manual zone. Z may correspond to a capacity of the corresponding AGV zone (e.g., a number SKUs or products that may be held or stored in the AGV zone). In some embodiments, WMS 119 may calculate a replenishment product inventory rate (and consequently Z) based on one or more of the following factors: a quantity of the corresponding SKUs sold, a quantity of the corresponding SKUs received in FC 200, a demand of the SKUs or products, a rate at which the corresponding SKU is received by FC 200 or sold, a condition of the SKUs or products (e.g., how aged a SKU or product is, how damaged or defective a SKU or product is, etc.), a length of the SKU, a weight of the SKU, a volume of the SKU, a storage temperature range of the SKU, a fragileness or fragility of the SKU, etc.

If Z is greater than a sum of the current inventory in a corresponding AGV zone and a replenishment product inventory rate of the corresponding AGV zone (e.g., if the corresponding AGV zone available space for receiving the SKU and its products), then at step 708, WMS 119 may direct up to “M” units of the SKU corresponding to the PO to the AGV zone of FC 200. M may be calculated by calculating the difference between Z and the sum of the current inventory in a corresponding AGV zone and a replenishment product inventory rate of the corresponding AGV zone.

From step 707, process 700 may also proceed to step 709. At step 709, WMS 119 may direct up to “N” units of the SKU corresponding to the PO to the manual zone of FC 200. N may be calculated by calculating a number of units of the SKU that exceed (e.g., are in excess of) the available capacity of the AGV zone.

Turning back to step 708, if the SKU is at a pallet station, then at step 710, WMS 119 may direct all of the units of the SKU corresponding to the PO to the AGV zone of FC 200.

In some embodiments, any combination of steps 704, 708, 709, or 710 may be performed substantially simultaneously. In some embodiments, any combination of steps 704, 708, 709, or 710 may not be performed substantially simultaneously.

Typical systems receive and allocate SKUs in a FC as follows: when a new PO is waiting to be received, the corresponding SKU is scanned on the received station; the SKU is checked to determine whether it is an AGV SKU; if it is an AGV SKU, then all units of the SKU in the PO will be directed to the AGV zone; if it is not an AGV SKU, then all units of the SKU in the PO will be directed to the manual zone. Process 700 is advantageous in that instead of simply directing SKUs to the AGV zone or the manual zone based on its SKU identifier, process 700 maximizes the AGV zone utilization and the manual zone utilization without overwhelming either zone, thereby increasing throughput, increasing efficiency of SKU processing, and increasing overall profitability.

It should be understood that any of processes 400, 500, 600, or 700 may be performed simultaneously. In some embodiments, various steps within process 400, 500, 600, or 700 may be performed simultaneously. Processes 400, 500, 600, or 700 are not limited to any particular order, and the disclosed embodiments include mixing steps of the different processes together.

Processes 400, 500, 600, 700, and any combination thereof, provide the flexibility to transport SKUs to either a manual zone or an AGV zone at the inbound point of the process, regardless of whether the SKU is registered as a manual SKU or an AGV SKU.

It should be understood that various steps of processes 400, 500, 600, or 700 may be performed by various components of a system (e.g., components of FIG. 3), and are not limited to the devices or systems described in the descriptions above.

FIG. 8 is a schematic diagram illustrating an AGV 810 and an AGV 820, consistent with the disclosed embodiments.

In some embodiments, each AGV may include one or more bins or shelves 830, where each bin or shelf may carry one or more products 832. In some embodiments, AGVs 810 and 820 may each include one or more motors, wheels, sensors, etc. (e.g., at 840 of the AGV) to enable AGVs 810 or 820 to be mobile.

In some embodiments, AGVs 810 and 820 may be managed by an external system (e.g., external system 350 of FIG. 3). In some embodiments, AGVs 810 or 820 may carry and transport one or more SKUs of products. AGVs 810 or 820 may traverse a certain area or zone of FC 200 that is separate from the areas or zones occupied by operators or mobile devices 119A, 119B, and 119C. Advantageously, AGVs 810 or 820 may transport various SKUs of products from storage in FC 200 to one or more terminals of FC 200, where operators or mobile devices may access the SKUs at these one or more terminals. That is, operators or mobile devices may remain stationary at one or more terminals while AGVs 810 or 820 transport SKUs in FC 200 between storage units and terminals.

It should be understood that while only two AGVs are depicted in FIG. 8, any number of AGVs may be used in a FC.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A computer-implemented system for intelligent allocation of products in a warehouse, the system comprising:
a memory storing instructions; and
at least one processor configured to execute the instructions to:
receive, by a user device, a purchase order comprising at least one product;
receive, by a user device, a stock keeping unit (SKU) identifier corresponding to a SKU received in a warehouse, wherein the SKU comprises the at least one product of the purchase order;
scan, by a user device, the SKU identifier;
determine, based on the scan of the SKU identifier, whether the SKU corresponds to an automated guided vehicle (AGV) zone of the warehouse;
when the SKU does not correspond to an AGV zone of the warehouse, command a mobile receptacle to transport the SKU to a manual zone of the warehouse;
when the SKU does correspond to an AGV zone of the warehouse:
determine whether the SKU identifier comprises a pallet tag, when the SKU identifier comprises a pallet tag:
command a mobile receptacle to transport the SKU to an AGV zone of the warehouse, and
command an AGV to stow the SKU in the AGV zone of the warehouse;
when the SKU identifier does not comprise a pallet tag:
calculate a first allocation of the at least one product to be directed to a manual zone of the warehouse and a second allocation of the at least one product to be directed to an AGV zone of the warehouse,
command a user device to transport the first allocation of the at least one product to a manual zone, and
command an AGV to transport the second allocation of the at least one product to an AGV zone.

2. The computer-implemented system of claim 1, wherein a pallet tag corresponds to a SKU with an increased rate of turnover in the warehouse.

3. The computer-implemented system of claim 2, wherein an increased rate of turnover in the warehouse corresponds to a SKU with an increased demand in at least one product of the SKU.

4. The computer-implemented system of claim 1, wherein a manual zone of the warehouse corresponds to an area of the warehouse where SKUs are processed by at least one operator.

5. The computer-implemented system of claim 1, wherein an AGV zone of the warehouse corresponds to an area of the warehouse where SKUs are processed by at least one AGV.

6. The computer-implemented system of claim 1, wherein calculating the first allocation and the second allocation comprises calculating a capacity of an AGV zone of the warehouse.

7. The computer-implemented system of claim 6, wherein calculating the capacity of an AGV zone of the warehouse comprises determining a current inventory of products in the AGV zone and a replenishment rate of products in the AGV zone.

8. The computer-implemented system of claim 7, wherein determining a replenishment rate of products in the AGV zone is based on at least one of a demand of each product, a condition of each product, a dimension of a SKU, a storage temperature range of a SKU, or a fragility of a SKU.

9. The computer-implemented system of claim 1, wherein when the second allocation of the at least one product exceeds a capacity of the corresponding AGV zone, then at least one processor is configured to execute the instructions to command a mobile receptacle to transport an excess quantity of products of the second allocation to a manual zone of the warehouse.

10. The computer-implemented system of claim 1, further comprising determining whether the SKU identifier comprises an expiration date or a manufacturing date.

11. The computer-implemented system of claim 10, wherein when the SKU identifier comprises an expiration date or a manufacturing date, then at least one processor is configured to execute the instructions to compare a manual zone identifier to an AGV zone identifier.

12. The computer-implemented system of claim 11, wherein the manual zone identifier and the AGV zone identifier each comprise at least one of an expiration date or a manufacturing date.

13. The computer-implemented system of claim 11, wherein when the manual zone identifier is earlier than the AGV zone identifier, then at least one processor is configured to execute the instructions to direct the at least one product to a manual zone of the warehouse.

14. The computer-implemented system of claim 11, wherein when the AGV zone identifier is earlier than the manual zone identifier, then at least one processor is configured to execute the instructions to direct the at least one product to an AGV zone of the warehouse.

15. The computer-implemented system of claim 1, wherein calculating the first allocation and the second allocation of the at least one product comprises maximizing a utilization of at least one of a manual zone and an AGV zone.

16. A computer-implemented method for intelligent allocation of products in a warehouse, comprising:
receiving, by a user device, a purchase order comprising at least one product;
receiving, by a user device, a stock keeping unit (SKU) identifier corresponding to a SKU received in a warehouse, wherein the SKU comprises the at least one product of the purchase order;
scanning, by a user device, the SKU identifier;
determining, based on the scan of the SKU identifier, whether the SKU corresponds to an automated guided vehicle (AGV) zone of the warehouse;
when the SKU does not correspond to an AGV zone of the warehouse, commanding a mobile receptacle to transport the SKU to a manual zone of the warehouse;
when the SKU does correspond to an AGV zone of the warehouse:
determining whether the SKU identifier comprises a pallet tag,
when the SKU identifier comprises a pallet tag:
commanding a mobile receptacle to transport the SKU to an AGV zone of the warehouse, and
commanding an AGV to stow the SKU in the AGV zone of the warehouse;
when the SKU identifier does not comprise a pallet tag:
calculating a first allocation of the at least one product to be directed to a manual zone of the warehouse and a second allocation of the at least one product to be directed to an AGV zone of the warehouse,
commanding a user device to transport the first allocation of the at least one product to a manual zone, and
commanding an AGV to transport the second allocation of the at least one product to an AGV zone.

17. The computer-implemented method of claim 16, wherein calculating the first allocation and the second allocation comprises calculating a capacity of an AGV zone of the warehouse.

18. The computer-implemented method of claim 17, wherein calculating the capacity of an AGV zone of the warehouse comprises determining a current inventory of products in the AGV zone and a replenishment rate of products in the AGV zone.

19. The computer-implemented method of claim 18, wherein determining a replenishment rate of products in the AGV zone is based on at least one of a demand of each product, a condition of each product, a dimension of a SKU, a storage temperature range of a SKU, or a fragility of a SKU.

20. A computer-implemented system for intelligent allocation of products in a warehouse, the system comprising:
a memory storing instructions; and
at least one processor configured to execute the instructions to:
receive, by a user device, a purchase order comprising at least one product;
receive, by a user device, a stock keeping unit (SKU) identifier corresponding to a SKU received in a warehouse, wherein the SKU comprises the at least one product of the purchase order;
scan, by a user device, the SKU identifier;
determine, based on the scan of the SKU identifier, whether the SKU corresponds to an automated guided vehicle (AGV) zone of the warehouse;
when the SKU does not correspond to an AGV zone of the warehouse, command a mobile receptacle to transport the SKU to a manual zone of the warehouse;
when the SKU does correspond to an AGV zone of the warehouse:
determine whether an AGV zone filter is activated,
if the AGV zone filter is not activated, then command a mobile receptacle to transport the SKU to a manual zone of the warehouse;
if the AGV zone filter is activated, then determine whether the SKU identifier comprises a pallet tag,
when the SKU identifier comprises a pallet tag:
command a mobile receptacle to transport the SKU to an AGV zone of the warehouse, and
command an AGV to stow the SKU in the AGV zone of the warehouse;
when the SKU identifier does not comprise a pallet tag:
calculate a first allocation of the at least one product to be directed to a manual zone of the warehouse and a second allocation of the at least one product to be directed to an AGV zone of the warehouse,
command a user device to transport the first allocation of the at least one product to a manual zone, and
command an AGV to transport the second allocation of the at least one product to an AGV zone.
